(19) United States
(12) Patent Application Publication
(10) Pub. No.: US 2026/0093464 A1
(43) Pub. Date: Apr. 2, 2026

(54) SYSTEMS AND METHODS FOR AUTOMATIC EVALUATION OF RENDERED USER INTERFACE USING MACHINE LEARNING

(71) Applicant: HSBC Software Development (Guangdong) Limited, Guangdong (CN)

(72) Inventors: Wei Ming Zhuang, Shanghai (CN); Benjamin Chodroff, Shanghai (CN); Junbao Duan, Shanghai (CN); Linlin GE, Shanghai (CN); Yuejia WU, Guangzhou (CN); Ziyuan LI, Shenzhen (CN)

(21) Appl. No.: 19/413,790

(22) Filed: Dec. 9, 2025

(30) Foreign Application Priority Data
Dec. 23, 2024 (CN) 202411912615.1

(51) Int. Cl. G06F 8/38; G06T 5/92; G06V 30/148; G06V 30/18; G06V 30/19

(52) U.S. Cl. CPC G06F 8/38; G06T 5/92; G06V 30/153; G06V 30/18095; G06V 30/19093

(57) ABSTRACT

Machine learning based computer devices, systems and methods are proposed for automating the evaluation and visual testing of graphical user interface (GUI) designs using a combination of image transformations for scoring the GUI designs and machine learning data architectures with a set of logical and conditional rules. The approach describes an automated process that transforms the GUI designs into clusters of pixels before using a chained series of image transformations to obtain similarity scores and underlying distributions for the GUI designs and then uses a machine learning data architecture in combination with a set of logical and conditional rules to computationally generate a prediction of error estimates based on the underlying distributions of the GUI designs.

### CROSS REFERENCE TO RELATED APPLICATIONS

This application claims priority to and the benefit of Chinese Application No. 202411912615.1, filed Dec. 23, 2024, the contents of which are incorporated into the present application by reference.

### FIELD

Embodiments of the present disclosure relate to computer architecture for automatic evaluation and visual testing of user interfaces (UI) using machine learning, and more specifically, embodiments relate to devices, systems and methods for machine-learning based comparison of UI designs using a combination of image transformations for scoring the UI designs to obtain similarity scores and underlying distributions for the UI designs and then using machine learning data architectures in combination with a set of logical and conditional rules to computationally generate a prediction of error estimates based on underlying distributions of the UI designs.

### INTRODUCTION

Visual testing is a software testing technique in software development that evaluates the visual appearance and behavior of a software application's user interface (UI). Visual testing aims to verify that the UI's visual elements (e.g., colors, images, fonts, and layouts) are displayed correctly and consistently across different devices, operating systems, and browsers. For example, UI errors can include localization issues with color schemes and UIs not matching, wrong screening resolutions, font sizes, magnifiers, operating systems not rendering, delays in texts being extracted from databases, Unicode text not rendering or presenting properly, issues rendering special characters, etc. The traditional approach is for a tester or designer to manually compare the target UI design with the tested UI. However, there are no current approaches that are robust enough to capture local feature points and descriptors while being able to adapt to scale invariance.

A technical challenge with manually visual testing UIs is that the comparison process is inefficient and prone to human error. Traditional processes often require a human tester to manually compare two UIs pixel-by-pixel, relying only on human vision to confirm whether two UI images are the same. There are usually no tools or rules that are incorporated into the process as it is typically an entirely human comparison process, leading to a need for several human testers. This is particularly significant for large organizations that would require a large number of UI testers and resources. Often, the UIs may have particular elements that require a trained designer tester to test their functionality, resulting in designer resources being limited to focus on testing.

Due to the manual nature of the process, testers are typically limited to choosing only one or two testing devices (e.g., iPhone 14) to ensure the UI images being tested have the same side measurements. As an illustrative example, a feature such as a button may be inaccessible to iPhone 14 users because it is hidden behind a text box due to limited screen space compared to the iPhone 16 pro max on which the feature was developed, which has larger screen dimensions. Testers can attempt to resize images to fit the screens on different types of devices, but this can lead to images with different pixels than the original image. The UI testing vendors that exist typically do not provide manuals or software support either.

It is desirable to have a robust system and method that is able to automatically compare and evaluate the similarity between two UI images (e.g., a UI test image and a UI target design image) such that the need for human manual resources can be minimized during the testing process, as well as being robust enough to capture localized features in the UI images and adapt to scaling invariance.

### SUMMARY

An improved computational approach is proposed herein that automates the evaluation and visual testing of user interfaces using a structured machine learning computer architecture, allowing for the design elements in the static design to be automatically compared and evaluated against a target GUI design data object to generate a prediction report of error estimates, which can be extrapolated into improved user interface rendering code to be deployed and adapted for dynamic usage on a diverse range of user interfaces. GUI designs can be provided in the form of wireframe illustration data objects, image renderings data objects, and can be in data object formats that can be used in applications that are configured for interface design. The GUI design data objects, during initial design and preparation, are configured for creative design, and the design data objects can include vector graphics representations that include static placeholders for dynamic interactive user interface control elements.

This artificial intelligence (AI) powered approach describes an automated process that uses a scoring engine to compare and score an UI test image and UI design image using similarity scoring algorithms before passing the scores into a test engine that scans the scores and evaluates the images in a chained process to generate a UI test error report. For example, the scoring engine can use optical character recognition (OCR) to inform a segmentation algorithm to first segment the UI images into a set of pixel clusters for comparison and scoring using the other similarity scoring algorithms. In this approach, each test input can be transformed into an intermediate version before being passed as input into the next scoring algorithm. The test engine can be configured to check for matches between the UI test image and UI design image with different threshold levels of matching, ranging from perfect matches (tight threshold) to loose matches (more relaxed threshold).

This approach uses AI to efficiently and accurately evaluate errors or differences between two UI image renderings, reducing development time and designer resources spent on visual testing, enhancing the completeness of error detection, and increasing the scalability and adaptability of mobile application development processes. The increased efficiency in the testing process that this approach offers will be a expandable financial benefit for large organizations with high expenditures in the quality and assurance testing stage of development.

The proposed approach can be used during a mobile development process where a designer wishes to implement a created design but the rendering code intended for that original design renders a graphical user interface that looks different than expected (e.g., missing icons, differences in visual elements that can only be noticed by designers). Typically, image comparison tools just use regression tests, but the proposed approach effectively detects and marks up all the differences between the rendered image and the original design and includes them in a test report that the system generates for the user (e.g., the designer) to consider to improve the rendering code during the development process.

The proposed approach can be used across a range of operating systems, testing platforms, devices, orientations and resolutions. All data can be saved on an internal server and does not require requesting a connection with external entities.

The proposed approach is an automated process that is configured to first transform the GUI design data objects into clusters of pixels before performing a series of chained image transformations on the clusters of pixels to obtain similarity scores that represent the level of similarity between the GUI design data objects in various aspects, such as plain text similarity, text region segment similarity, graphics region segment similarity, image semantic similarity, graphics structure similarity, graphics feature and key point similarity, etc. The generated similarity scores are then inputted into a test engine, which consists of a rule engine and a machine learning computer architecture, to scan the difference between the GUI design data objects based on the similarity scores. The test engine then generates and outputs a GUI test error report, which can be represented by a list of predictions of estimated errors based on underlying distributions of the GUI design data objects.

In some embodiments, the proposed system is further configured to computationally generate improved deployment capable code packages based on the generated UI test report to construct GUI design data objects that are more similar to the target GUI design data object. The improved deployment capable code packages can be automatically adapted for test or production usage and rendering on a user interface rendering engine that is operating on a computing device, such as a mobile device, or provisioning to a hosting instance, such as a web server, that dynamically generates output interfaces that are served to a requesting computing device for rendering thereon (e.g., a web server operating in a model-view-controller architecture) using a web development scripting engine such as a PHP interpreter. In this example, the generated deployment capable code packages can be PHP code that is processed on a web server, and when interacted with by the requesting computing device, the web server serves up generated hyper-text markup language (HTML) or other binary image data, as a hypertext transfer protocol response.

In some embodiments, the proposed approach can further generate a similar UI design for output to the user, automatically adapted based on real world devices and rendering engine limitations and characteristics. Based on the generated UI test report, the system can generate a deployable UI rendering code package for an improved UI design that is capable of immediate deployment into a test or production environment. The deployable UI rendering code package is deployed through a package update by a package manager or pushed as an application update. For example, when a mobile application for an online banking platform is updated, the UI rendering code can be picked up by the client side device and automatically utilized.

The computational approach proposed herein improves the process of evaluating and visual testing GUI designs by providing a solution to the issue of manually comparing UI designs being time-consuming, resource-consuming and prone to human error, which hinders rapid application development. Existing tools have limitations in accurately capturing and comparing GUI specifications and components, which often results in inaccurate test reports of the GUI designs. Furthermore, existing tools are incapable of handling significant scaling up as the GUI design comparisons are all done manually. This gap between design and functional implementation leads to increased development time and inconsistency in user interfaces across different platforms.

Embodiments described herein provide a computing system for automated visual testing of graphical user interface designs using image transformations for scoring and evaluation. The system includes a computer processor operating in conjunction with computer memory and a non-transitory computer readable data storage. The computer processor is configured to receive a candidate data object and a reference data object from a user, where each data object represents a graphical user interface design. The computer processor is configured to transform the candidate and reference data objects into a candidate and reference machine-encoded text objects using optical character recognition for comparison of textual and layout features to generate a first similarity score; segment the candidate and reference machine-encoded text objects into a candidate and reference sets of pixel clusters using object masks; generate a candidate and reference image histograms based on the distribution of pixels of the candidate and reference sets of pixel clusters for comparison of color distribution characteristics as between the candidate and reference image histograms to generate a second similarity score; generate a candidate and reference embedding vectors through image embedding based on the candidate and reference sets of pixel clusters for calculation of a third similarity score, where the third similarity score is a cosine similarity score between the candidate and reference embedding vectors; localize sub-clusters of the candidate and reference sets of pixel clusters to perform template matching between the candidate and reference data objects to generate a fourth similarity score; compute and extract a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects; and transform the candidate and reference sets of pixel clusters into greyscale format for comparison of luminance and contrast between each pixel of the candidate set of pixel clusters and each pixel of the reference set of pixel clusters to generate a sixth similarity score. The computer processor is further configured to provide the first, second, third, fourth, fifth and sixth similarity scores to a trained machine learning model data architecture for scanning and comparison against a set of passing threshold values; and generate an output structured data object based on the comparison of the first, second, third, fourth, fifth, and sixth similarity scores against the set of passing threshold values, the output structured data object containing a list of ordered pairs, where each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, where the output structured data object can be used by the user to correct the difference between the candidate and reference data objects for each ordered pair of the list of ordered pairs.

In some embodiments, the computer processor is further configured to generate a set of recommended text instructions for an improved rendering of the reference data object by inputting the reference data object and the generated output structured data object into a system for automatic generation of user interface rendering code, where the generated set of recommended text instructions can be transmitted to a development testing environment for compilation and execution as a rendered user interface visual element accessible to the user.

In some embodiments, the computer processor is further configured to obtain a set of similarity scores for the improved rendering of the reference data object; set a first level development threshold for the set of similarity scores; determine the set of similarity scores reaches or exceeds the first level development threshold associated with the set of similarity scores; and in response to reaching or exceeding the value of the first level development threshold, automatically transmit the generated set of recommended text instructions to a development testing environment for compilation and execution as a rendered user interface visual element accessible to the user.

In some embodiments, the computer processor is further configured to set a second level production threshold for the set of similarity scores; determine the set of similarity scores reaches or exceeds the second level production threshold; and in response to reaching or exceeding the value of the second level production threshold, automatically deploy the generated set of recommended text instructions to a production server accessible to a plurality of users.

In some embodiments, the computer processor is further configured to compile the generated set of recommended text instructions to generate a set of machine language instructions; and output the generated set of machine language instructions to the user for re-implementation of a user interface visual element.

In some embodiments, the computer processor is further configured to link the set of machine language instructions into an executable binary file, wherein the executable binary is an aggregation of the set of machine language instructions; and output the executable binary file to the user for re-implementation of a user interface visual element.

In some embodiments, the computer processor is further configured to run the executable binary file to render a graphical user interface at runtime; and output the rendered graphical user interface to the user for re-implementation of a user interface visual element.

In some embodiments, the computer processor is further configured to set a third level discard threshold for the set of similarity scores; determine the set of similarity scores does not reach the third level discard threshold; and in response to not reaching the value of the third level discard threshold, automatically discard the generated set of recommended text instructions.

In some embodiments, the computer processor is further configured to replace text objects from the candidate and reference data objects with one or more clusters of white pixels by applying the object masks to the candidate and reference machine-encoded text objects before the computer processor segments the candidate and reference machine-encoded text objects.

In some embodiments, the computer processor is further configured to replace graphical symbol objects from the candidate and reference data objects with the one or more clusters of white pixels by applying the object masks to candidate and reference machine-encoded text objects before the computer processor segments the candidate and reference machine-encoded text objects.

In an aspect, embodiments described herein provide a computing method for automated visual testing of graphical user interface designs using image transformations for scoring and evaluation. The method involves receiving a candidate data object and a reference data object from a user, each data object representing a graphical user interface design. The method involves transforming the candidate and reference data objects into a candidate and reference machine-encoded text objects using optical character recognition for comparison of textual and layout features to generate a first similarity score; segmenting the candidate and reference machine-encoded text objects into a candidate and reference sets of pixel clusters using object masks; generating a candidate and reference image histograms based on the distribution of pixels of the candidate and reference sets of pixel clusters for comparison of color distribution characteristics as between the candidate and reference image histograms to generate a second similarity score; generating a candidate and reference embedding vectors through image embedding based on the candidate and reference sets of pixel clusters for calculation of a third similarity score, where the third similarity score is a cosine similarity score between the candidate and reference embedding vectors; localizing sub-clusters of the candidate and reference sets of pixel clusters to perform template matching between the candidate and reference data objects to generate a fourth similarity score; computing and extracting a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects; and transforming the candidate and reference sets of pixel clusters into greyscale format for comparison of luminance and contrast between each pixel of the candidate set of pixel clusters and each pixel of the reference set of pixel clusters to generate a sixth similarity score. The method further involves providing the first, second, third, fourth, fifth and sixth similarity scores to a trained machine learning model data architecture for scanning and comparison against a set of passing threshold values; and generating an output structured data object based on the comparison of the first, second, third, fourth, fifth, and sixth similarity scores against the set of passing threshold values, the output structured data object containing a list of ordered pairs, where each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, where the output structured data object can be used by the user to correct the difference between the candidate and reference data objects for each ordered pair of the list of ordered pairs.

In some embodiments, the computing method further involves generating a set of recommended text instructions for an improved rendering of the reference data object by inputting the reference data object and the generated output structured data object into a system for automatic generation of user interface rendering code, where the generated set of recommended text instructions can be transmitted to a development testing environment for compilation and execution as a rendered user interface visual element accessible to the user.

In some embodiments, the computing method further involves obtaining a set of similarity scores for the improved rendering of the reference data object; setting a first level development threshold for the set of similarity scores; determining the set of similarity scores reaches or exceeds the second level production threshold; and in response to the reaching or exceeding the value of the first level development threshold, automatically transmitting the generated set of recommended text instructions to a development testing environment for compilation and execution as a rendered user interface visual element accessible to the user.

In some embodiments, the computing method further involves: setting a second level production threshold for the set of similarity scores; determining the set of similarity scores reaches or exceeds the second level production threshold; and in response to reaching or exceeding the value of the second level production threshold, automatically deploying the generated set of recommended text instructions to a production server accessible to a plurality of users.

In some embodiments, the computing method further involves compiling the generated set of recommended text instructions to generate a set of machine language instructions; and outputting the generated set of machine language instructions to the user for re-implementation of a user interface visual element.

In some embodiments, the computing method further involves: linking the set of machine language instructions into an executable binary file, where the executable binary is an aggregation of the set of machine language instructions; and outputting the executable binary file to the user for re-implementation of a user interface visual element.

In some embodiments, the computing method further involves: running the executable binary file to render a graphical user interface at runtime; and outputting the rendered graphical user interface to the user for re-implementation of a user interface visual element.

In some embodiments, the computing method further involves setting a third level discard threshold for the set of similarity scores; determining the set of similarity scores does not reach the third level discard threshold; and in response to not reaching the value of the third level discard threshold, automatically discarding the generated set of recommended text instructions.

In some embodiments, the computing method further involves replacing text objects from the candidate and reference data objects with one or more clusters of white pixels by applying the object masks to the candidate and reference machine-encoded text objects before the computer processor segments the candidate and reference machine-encoded text objects.

In accordance with an aspect, there is provided a non-transitory computer readable medium storing computer interpretable instructions, which when executed by a computer processor, cause the computer processor to perform a method for automated visual testing of graphical user interface designs using image transformations for scoring and evaluation. The method involves receiving a candidate data object and a reference data object from a user, each data object representing a graphical user interface design. The method involves transforming the candidate and reference data objects into a candidate and reference machine-encoded text objects using optical character recognition for comparison of textual and layout features to generate a first similarity score; segmenting the candidate and reference machine-encoded text objects into a candidate and reference sets of pixel clusters using object masks; generating a candidate and reference image histograms based on the distribution of pixels of the candidate and reference sets of pixel clusters for comparison of color distribution characteristics as between the candidate and reference image histograms to generate a second similarity score; generating a candidate and reference embedding vectors through image embedding based on the candidate and reference sets of pixel clusters for calculation of a third similarity score, where the third similarity score is a cosine similarity score between the candidate and reference embedding vectors; localizing sub-clusters of the candidate and reference sets of pixel clusters to perform template matching between the candidate and reference data objects to generate a fourth similarity score; computing and extracting a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects; and transforming the candidate and reference sets of pixel clusters into greyscale format for comparison of luminance and contrast between each pixel of the candidate set of pixel clusters and each pixel of the reference set of pixel clusters to generate a sixth similarity score. The method further involves providing the first, second, third, fourth, fifth and sixth similarity scores to a trained machine learning model data architecture for scanning and comparison against a set of passing threshold values; and generating an output structured data object based on the comparison of the first, second, third, fourth, fifth, and sixth similarity scores against the set of passing threshold values, the output structured data object containing a list of ordered pairs, where each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, where the output structured data object can be used by the user to correct the difference between the candidate and reference data objects for each ordered pair of the list of ordered pairs.

Many further features and combinations thereof concerning embodiments described herein will appear to those skilled in the art following a reading of the instant disclosure.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a flow diagram of an example system for automatic evaluation and visual testing of a GUI test image against a GUI design image, according to some embodiments.

FIG. 2 is a process diagram of an example OCR engine of a system for automatic evaluation and visual testing of a GUI test image against a GUI design image, according to some embodiments.

FIG. 3 is a process diagram of an example test engine of a system for automatic evaluation and visual testing of a whole GUI test image against a GUI design image, according to some embodiments.

FIG. 4 is a process diagram of an example test engine of a system for automatic evaluation and visual testing of a segmented OCR text region of a GUI test image against a GUI design image, according to some embodiments.

FIG. 5 shows an example comparison using a market solution computer approach for automatic evaluation and visual testing of a GUI test image against a GUI design image, according to some embodiments.

FIG. 6 shows an example user interface for a user to provide an input GUI design image and GUI test image to system for automatic evaluation and visual testing of the input images, according to some embodiments.

FIG. 7 shows an example GUI test image and an example GUI design image for comparison, according to some embodiments.

FIG. 8 shows an example GUI test report generated by the proposed system for an example GUI test image and an example GUI design image, according to some embodiments.

### DETAILED DESCRIPTION

An improved computational approach is proposed herein that automates the evaluation and visual testing of user interfaces using a structured machine learning computer architecture, allowing for the design elements in the static design to be automatically compared and evaluated against a target GUI design data object to generate a prediction report of error estimates, which can be extrapolated into improved user interface rendering code to be deployed and adapted for dynamic usage on a diverse range of user interfaces. GUI designs can be provided in the form of wireframe illustration data objects, image renderings data objects, and can be in data object formats that can be used in applications that are configured for interface design. The GUI design data objects, during initial design and preparation, are configured for creative design, and the design data objects can include vector graphics representations that include static placeholders for dynamic interactive user interface control elements.

The approaches proposed herein assist in improving computing and resource efficiency when computing at a large scale. Essentially, a computer science and resource complexity challenge that arises when scaling at large instance size is overcome through an automated transformation application proposed herein. By automating the evaluation and visual testing of GUI designs, the approaches proposed herein effectively bridge the gap between UI/UX design and mobile application development to improve both productivity and product quality.

Computer devices, systems and methods proposed herein automatically compare GUI designs using scoring image transformations and a machine learning computer architecture such that repetitive human manual activity can be minimized in evaluating the difference between GUI designs, as well as still being accurate.

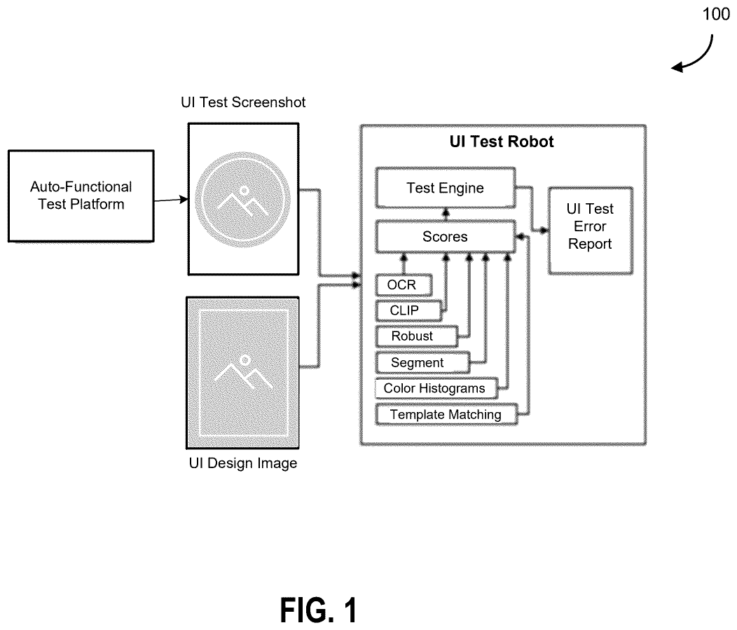

FIG. 1 is a flow diagram of an example system for automatic evaluation and visual testing of a GUI test image against a GUI design image, according to some embodiments.

System 100 involves an automated process that is configured to first transform the GUI design data objects into clusters of pixels before performing a series of chained image transformations on the clusters of pixels to obtain similarity scores that represent the level of similarity between the GUI design data objects in various aspects, such as plain text similarity, text region segment similarity, graphics region segment similarity, image semantic similarity, graphics structure similarity, graphics feature and key point similarity, etc. The generated similarity scores are then provided as input into a test engine, which consists of a rule engine and a machine learning computer architecture, to scan the difference between the GUI design data objects based on the similarity scores. The test engine then generates and outputs a GUI test error report, which can be represented by a list of predictions of estimated errors based on underlying distributions of the GUI design data objects.

System 100 utilizes various algorithms or computational approaches to perform the image transformations on the GUI design data objects.

Table 1 below shows the different algorithms that can be utilized to obtain similarity scores based on different types of features.

| Comparison Item | SIFT | CLIP | Color Histograms | Template Matching |
|---|---|---|---|---|
| Feature Type | Local feature points | High-dimensional | Color distribution in | Localized regions of |
| | and descriptors (key | feature vectors | images | image that match |
| | points, edges) | (512D), including | | template image |
| | | object, scene, | | |
| | | semantics, color, | | |
| | | shape, etc. | | |
| Algorithm | Scale invariance, | Multimodal (joint | Statistical analysis of | Sliding window |
| Characteristics | rotation invariance, | image and text | color distribution in | searches for |
| | robust to | training), high | different regions | template matches in |
| | illumination changes | semantic | | target image |
| | | understanding, | | |
| | | cross-modal | | |
| | | capability | | |
| Computational | High, suitable for | Medium to high, | Low, suitable for | Medium, suitable for |
| Complexity | offline processing | depends on GPU, | real-time and offline | real-time and offline |
| | | suitable for real-time | processing | processing |
| | | processing | | |
| Community | Strong, widely used | Strong, especially in | Strong, widely used | Strong, widely used |
| Support | in computer vision | multimodal research | in various image | in image processing |
| | research and | in NLP and CV | processing | applications |
| | engineering practice | | applications | |
| Dependant | OpenCV(BSD | Transformers library | OpenCV (BSD | OpenCV (BSD |
| Libraries | License) | (MIT License) | License) | License) |
| Resource | Middle CPU and | High GPU and | Low, suitable for | Low to medium, |
| Requirements | memory | memory | both real-time and | suitable for both |
| | requirements, | requirements, | offline processing | real-time and offline |
| | especially when | suitable for high- | | processing |
| | processing large | performance | | |
| | image data | computing resources | | |

| Comparison Item | OpenCV and SSIM | Segment (Long Term) | OCR |
|---|---|---|---|
| Feature Type | Global structural | Object masks and | Textual features, |
| | similarity (brightness, | boundaries, segment | character |
| | contrast, structure) | labels | recognition, layout |
| | | | analysis |
| Algorithm | Perception-driven, | High precision, works | Recognizes and |
| Characteristics | structural similarity | on any object with | extracts text from |
| | evaluation | few clicks, robust | images, robust to |
| | | segmentation | various fonts and |
| | | | styles |
| Computational | Low to medium, | Medium to high, | Medium to high, |
| Complexity | suitable for real-time | depends on GPU | depending on the |
| | processing | suitable for real-time | OCR model, suitable |
| | | and offline | for both real-time |
| | | processing | and offline |
| | | | processing |
| Community | Strong, widely used | Strong, widely used | Strong, widely used |
| Support | in image processing | in computer vision | in document |
| | and analysis | research and | processing, form |
| | | practical applications | recognition, and |
| | | | automation |
| Dependant | OpenCV (BSD | Segment(Apache 2.0 | EasyOCR (Apache 2.0 |
| Libraries | License), skimage | License) | License) |
| | (BSD License) | | |
| Resource | Low resource | Medium to high, | Medium to high, |
| Requirements | requirements, | suitable for both | depending on the |
| | suitable for various | real-time and offline | model complexity, |
| | computing | processing | suitable for both low |
| | environments | | and high-resource |
| | | | environments |

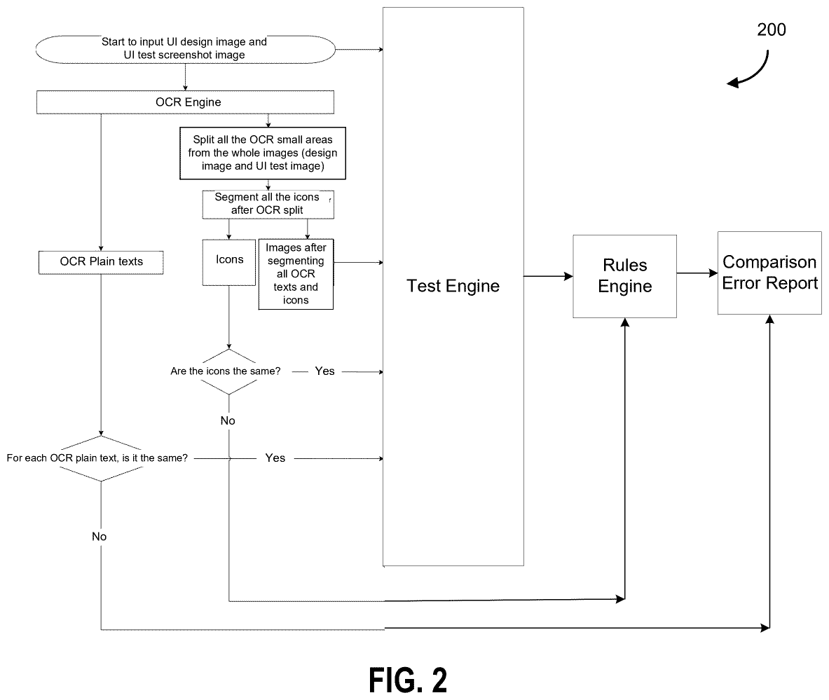

Optical character recognition (OCR) is a computational process that converts an image of text into a machine-readable text format. OCR can be used to compare the textual, character, and layout features between two images by recognizing and extracting text from images. OCR is robust to various fonts and styles and can be suitable for both real-time and offline processing. OCR is typically the first transformation and process that is applied to the GUI design objects in system 100 (see FIG. 2 below).

Segmentation is a computation process of partitioning a digital image into multiple image segments, also known as image regions or image objects (sets/clusters of pixels). Segmentation can utilize object masks to separate the image segments. Segmentation can be applied to the GUI design objects in system 100 after the OCR process (see FIG. 2 below).

Object masking is used to isolate a particular item/object or section of an image. Object masking removes unwanted portions of an image by locating boundaries of those unwanted portions or objects and placing an object mask along those boundaries. In some embodiments, the object masks can be raster masks made up of a grid of pixels, each of which can be set to either opaque or transparent. In some embodiments, the object masks can be vector masks made up of a series of points, lines, and curves that can be combined to create masks with complex shapes. In some embodiments, the objects masks can be bitmap masks made up of a series of bits that determine whether a pixel is black or white.

In some embodiments, the OCR-processed objects can be segmented such that any text present in the original GUI design objects is separated and segmented out. For example, a bitmap object mask can be used to mark all the text regions in the OCR-processed objects as white pixels while keeping all other regions of the OCR-processed objects as their original pixels.

In some embodiments, the OCR-processed objects can be segmented such that any icons present in the original GUI design objects is separated and segmented out.

Scale-invariant feature transform (SIFT) is a computer vision approach to detect, describe, and match local features in images. SIFT provides a comparison of local feature points and descriptors (e.g., key points, edges, etc.) between two images or GUI design objects. SIFT is robust to scale invariance, rotation invariance, and illumination changes. SIFT has a higher computational complexity and is more suited to offline processing.

Contrastive language-image pre-training (CLIP) is a computational approach for comparing image features, such as objects, scene, semantics, color, shape, etc. CLIP determines the similarity between two images by computing embedding vectors (a numerical representation) of the two images. The cosine similarity score between the two embedding vectors can then be calculated. CLIP operates based on multimodal joint image and text training with a high semantic understanding and natural language learning capabilities.

Color histograms can be used to measure the similarity of color distribution in images. Color histograms are a graphical representation of the distribution of colors in an image that can be statistically analyzed for color distribution in different regions. Color histograms have low computation complexity and are suitable for both real-time and offline processing.

Template matching is a digital image processing approach for finding small parts of an image (i.e., the GUI test image) which match a template image (i.e., the GUI design image). Template matching localizes regions of the GUI test image that match the GUI design image by utilizing sliding window searches.

Structural similarity index measure (SSIM) is a computational approach for determining global structural similarity between two images, namely, the similarity of brightness, contrast, and structure in the images. SSIM compares the structural features of the two images by comparing similarities within pixels (i.e. if the pixels in the two images line up and or have similar pixel density values).

Applicant has chosen the computational approaches in Table 1 because they each provide a comparison and similarity score for a different parameter of one image (e.g., structure, color, pixels, etc.).

As an example, embodiments described herein receive a candidate UI test screenshot image data object and a reference UI design image data object from a user. The OCR engine transforms the candidate and reference data objects into candidate and reference machine-encoded text objects using OCR for comparison of textual and layout features to generate a first similarity score. The OCR engine then segments the candidate and reference machine-encoded text objects into a candidate set and reference set of pixel clusters using object masks.

Using the intermediate product of the candidate set and reference set of pixel clusters, the test engine can then generate a corresponding image histogram, embedding vectors, sub-clusters, and a set of descriptor objects for each of the candidate set and reference set of pixel clusters.

The test engine can generate the image color histograms based on the distribution of pixels of the candidate and reference sets of pixel clusters for comparison of color distribution characteristics to generate a second similarity score.

The test engine can generate the embedding vectors through image embedding for the CLIP approach based on the candidate and reference sets of pixel clusters for calculation of a cosine similarity score between the candidate and reference embedding vectors as a third similarity score. The test engine can localize sub-clusters of the candidate and reference sets of pixel clusters to perform template matching to generate a fourth similarity score.

The descriptor objects can be computed and extracted by the test engine based on local intensity extrema of the candidate and reference sets of pixel clusters for comparison using the SIFT approach involving each descriptor object from the candidate set of descriptor objects being compared to each descriptor object of the reference set of descriptor objects to generate a fifth similarity score.

The test engine can then transform the candidate and reference sets of pixel clusters into greyscale format for comparison of luminance and contrast between each pixel of the candidate set of pixel clusters and each pixel of the reference set of pixel clusters using the SSIM approach to generate a sixth similarity score. The test engine can provide the first, second, third, fourth, fifth and sixth similarity scores to a trained machine learning model data architecture for scanning and comparison against a set of passing threshold values that are preset in the system. The test engine then generates an output UI test report structured data object based on the comparison of the first, second, third, fourth, fifth, and sixth similarity scores against the set of passing threshold values.

The UI test report data object contains a list of ordered pairs, where each ordered pair comprises a candidate pixel cluster of the candidate set of pixel clusters and a corresponding reference pixel cluster of the reference set of pixel clusters, where the candidate pixel cluster and the corresponding reference pixel cluster are detected by the trained machine learning model data architecture as being a difference between the candidate and reference data objects. The output UI test report structured data object can then be used by the user to correct the difference between the candidate and reference data objects for each ordered pair of the list of ordered pairs.

FIG. 2 is a process diagram of an example OCR engine of a system for automatic evaluation and visual testing of a GUI test image against a GUI design image, according to some embodiments. Process 200 is focused on the OCR transformation step of system 100.

Process 200 begins with inputting a reference UI design image data object and candidate UI test screenshot image data object into an OCR engine and test engine of system 100.

The OCR engine performs an OCR process on the reference UI design image data object and candidate UI test screenshot image data object to convert them into machine-encoded text objects to prepare for segmentation.

In some embodiments, the OCR engine will use OCR to identify and extract plain texts from the images. If an OCR plain text appears to be the same in the UI design image and the UI test screenshot image, then the OCR plain text is provided to the test engine as input for similarity analysis and scoring. If the OCR plain text appears to be different in the UI design image and the UI test screenshot image, then the OCR plain text will be included in the comparison error report as a noted difference or error.

In some embodiments, the OCR engine will use OCR to split the images into OCR small regions and areas from the whole images (both the UI design image and the UI test screenshot image). In some embodiments, icons present in the OCR small regions and areas will be segmented out after the OCR process. After segmenting out all the OCR texts and icons, the images are provided to the test engine as input for further similarity analysis and scoring. If the segmented out icons appear to be the same in both images, the icons will be provided to the test engine as input for further similarity analysis and scoring. If the segmented out icons appear to be different, then the icons will be included in the comparison error report as a noted difference or error.

In some embodiments, the OCR engine is further configured to replace text objects from the candidate UI test screenshot image and reference UI design image data objects with one or more clusters of white pixels by applying object masks to the candidate UI test screenshot image and reference UI design image machine-encoded text objects before the OCR engine segments the candidate and reference machine-encoded text objects.

In some embodiments, the OCR engine is further configured to replace graphical symbol objects and icons from the candidate UI test screenshot image and reference UI design image data objects with the one or more clusters of white pixels by applying the object masks to the candidate UI test screenshot image and reference UI design image machine-encoded text objects before the OCR engine segments the candidate and reference machine-encoded text objects.

After scores have been generated for the images in the test engine, the scores are forwarded to the rules engine for determination of items to be included in the comparison error report.

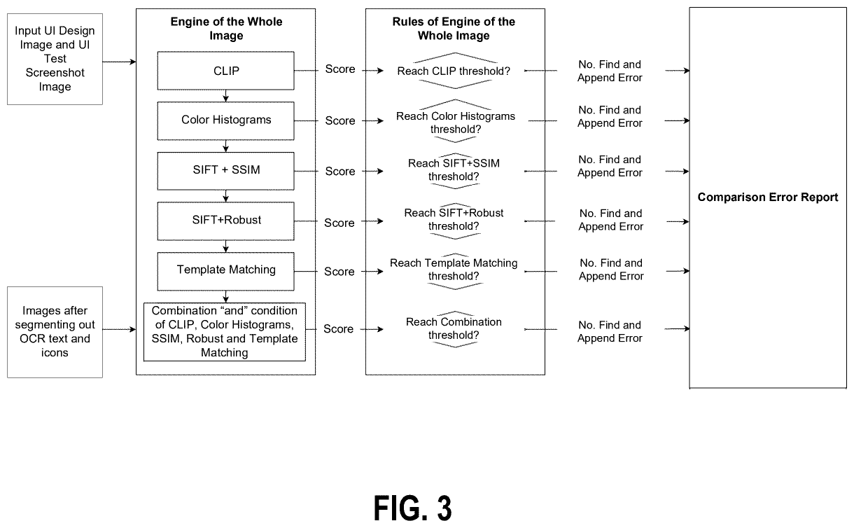

FIG. 3 is a process diagram of an example test engine of a system for automatic evaluation and visual testing of a whole GUI test image against a GUI design image, according to some embodiments.

Process 300 illustrates the similarity analysis and scoring process of a whole GUI test image against a GUI design image. The UI design image and UI test screenshot image, in their original form or in their form after the OCR texts and icons have been segmented out, are provided to the test engine as inputs.

In the test engine, various different computational approaches and transformations will be applied to the images. As shown in FIG. 3, in some embodiments, the images will be processed by CLIP, color histograms, SSIM, SIFT+Robust, and template matching, each of which generating a similarity score to be provided to the rules engine as input.

The rules engine contains a minimum score threshold and checkpoint/conditional logic for each similarity score to verify whether each type of similarity score satisfies the minimum required levels of similarity. If a similarity score is lower than their corresponding threshold value, then the scored feature and the similarity score will be appended as an error to the comparison error report.

In some embodiments, the test engine also applies a conditional combination of the individual computational approaches to the images to account for a combination similarity score. The combination similarity score is useful in situations where the UI test screenshot images is highly similar to the UI design image and it is difficult to find small differences between the two images. For example, if UI test screenshot image scored 0.92 in all the individual computational approach comparisons, the combination approach can potentially provide a lower score of 0.9, which would be a better representation of a potential error or difference present in the image.

The test engine operates by utilizing a machine learning computer architecture. The machine learning computer architecture is trained on a data set of screenshots of application pages. For example, in the context of a banking mobile application on an iPhone 14 device, the machine learning computer architecture can be trained on 200 screenshots of pages of the banking mobile application taken on an iPhone 14 device. As another example, the machine learning computer architecture can also maintain a separate training data set for a Samsung Galaxy S22 device by collecting 200 screenshots of pages of the banking mobile application taken on a Samsung Galaxy S22 device.

For other examples, such as e-commerce applications, stock websites, etc., the business purpose and pages of the application or website can be more complex than banking mobile application pages, which would require a larger training data set with more images to train the machine learning computer architecture on.

The training data sets can then be provided to the test engine (scoring engine) as input to obtain scores for each of the test screenshot pages in the training data sets. The machine learning computer architecture can be trained on these training data sets.

The machine learning computer architecture can then categorize the scores of the UI test screenshot image as a pass or not pass by comparing them against the set thresholds for each computational approach.

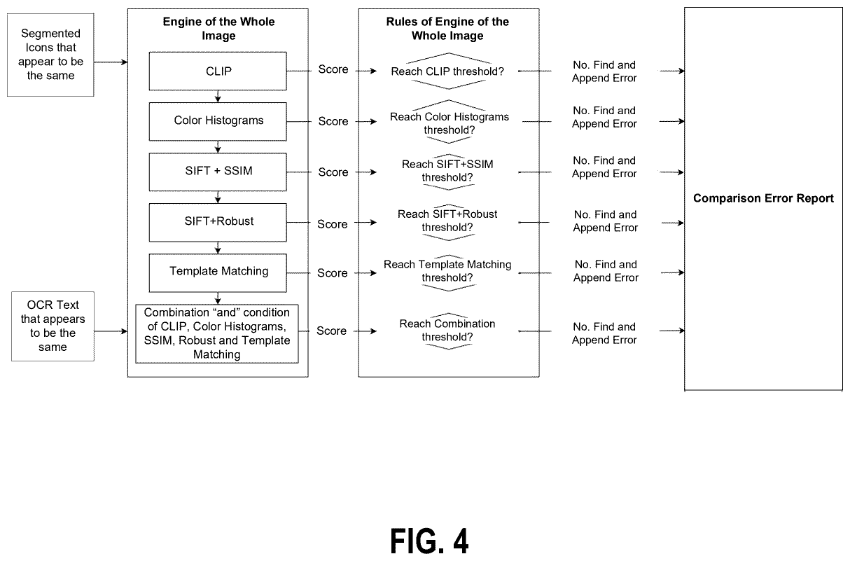

FIG. 4 is a process diagram of an example test engine of a system for automatic evaluation and visual testing of a segmented OCR text region of a GUI test image against a GUI design image, according to some embodiments.

Process 400 illustrates the similarity analysis and scoring process of a segmented icon or OCR text region from a GUI test image against a GUI design image. The segmented icons or OCR text regions that appear to be the same in both images are provided to the test engine as inputs.

In the test engine, various different computational approaches and transformations will be applied to the images. As shown in FIG. 4, in some embodiments, the image segments will be processed by CLIP, color histograms, SSIM, SIFT+Robust, and template matching, each of which generating a similarity score to be provided to the rules engine as input.

The rules engine contains a minimum score threshold and checkpoint/conditional logic for each similarity score to verify whether each type of similarity score satisfies the minimum required levels of similarity. If a similarity score is lower than their corresponding threshold value, then the scored feature and the similarity score will be appended as an error to the comparison error report.

In some embodiments, the test engine also applies a conditional combination of the individual computational approaches to the image segments to account for a combination similarity score. The combination similarity score is useful in situations where an icon in the UI test screenshot image is highly similar to that of the UI design image and it is difficult to find small differences between the two icons. For example, if the icon in the UI test screenshot image scored 0.92 in all the individual computational approach comparisons, the combination approach can potentially provide a lower score of 0.9, which would be a better representation of a potential error or difference present in the icons.

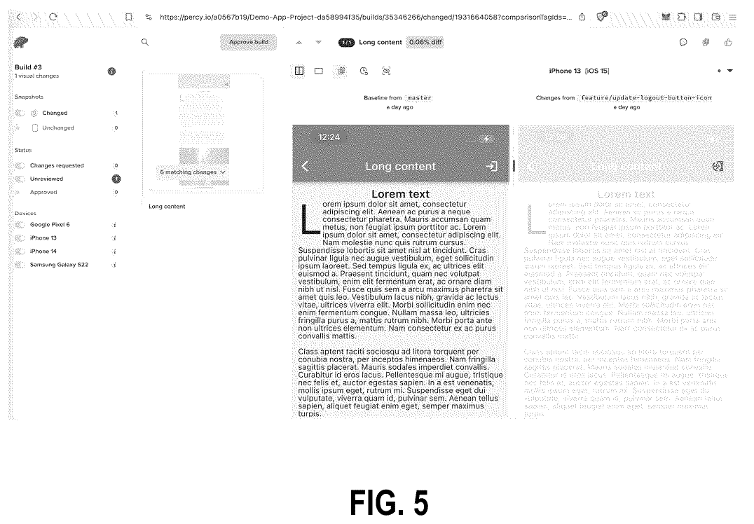

FIG. 5 shows an example comparison using a market solution computer approach for automatic evaluation and visual testing of a GUI test image against a GUI design image, according to some embodiments.

Table 2 shows the results of comparing the computational approach proposed herein and Percy.

Lab Solution vs. Percy: Comparison Results

| Comparison | | | |
|---|---|---|---|
| category | Comparison Item | Percy | Lab |
| Technical | Graphic Detection (in pixel) | [symbol] | [symbol] |
| Algorithm | Robust (Local feature points and | X | [symbol] |
| | descriptors, Scale invariance) | | |
| | Color Histo (Color distribution | X | [symbol] |
| | characteristics) | | |
| | CLIP (High-dimensional feature vector, | X | [symbol] |
| | containing information like objects, | | |
| | scenes, semantics, colors, shapes, etc.) | | |
| | OCR (Textual features, character | X | [symbol] |
| | recognition, layout analysis) | | |
| | Template Matching (find a portion of | X | [symbol] |
| | a design image that matches a segment | | |
| | from a test image) | | |
| | AI trained score engine | X | [symbol] |
| | (Combines all the scores above) | | |
| Product Easy | Can be integrated into CI/CD pipelines | [symbol] | [symbol] |
| to Use | Works with HSBC framework as the | [symbol] | [symbol] |
| | input images | | |
| | Easy to setup on Cloud, with extensive | [symbol] | [symbol] |
| | documentation | | |
| Data/Network/ | Save HSBC test images internal HSBC | X | [symbol] |
| Architecture | No public internet network connection | X | [symbol] |
| Security | | | |

The computational approach proposed herein is capable of comparing more properties of the images than Percy can. For example, Percy does not compare local feature points and descriptors or color distribution characteristics during its pixel-by-pixel comparison. Percy also uses more computational cost and has a higher computational complexity, using more CPU and memory space than the computational approach proposed herein.

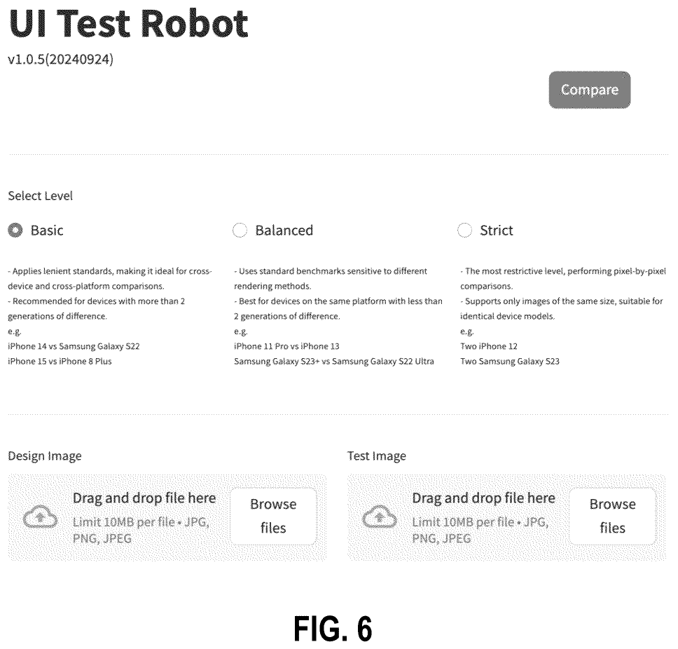

FIG. 6 shows an example user interface for a user to provide an input GUI design image and GUI test image to system for automatic evaluation and visual testing of the input images, according to some embodiments.

The proposed computational system shown in FIG. 6 offers three levels of similarity testing. The first option is a “basic level” where the system will apply lenient standards and use a relaxed threshold when checking for matches and similarity scores between images. This option is ideal for cross-device and cross-platform comparisons as differences between, for example, two devices with more than 2 generations of difference may be overlooked when using these lenient standards. For example, this option can be applied for comparing an image taken on an iPhone 15 device and an image on an iPhone 8 plus device.

The second option is a “balanced level” where the system will apply standard benchmarks sensitive to different rendering methods to check for an acceptable match and similarity score between images. This option is ideal for devices on the same platform with less than 2 generations of difference. For example, this option can be applied for comparing an image taken on an iPhone 11 Pro device and an image on an iPhone 13 device.

The third option is a “strict level” where the system applies a restrictive standard by performing pixel-by-pixel comparisons. This option utilizes a tight threshold to find near-perfect matches and supports only images of the same size. This option is suitable for identical device models. For example, this option can be applied for comparing two images taken on iPhone 12 devices.

FIG. 6 further shows the option to upload a design image and a test image for the system to run on.

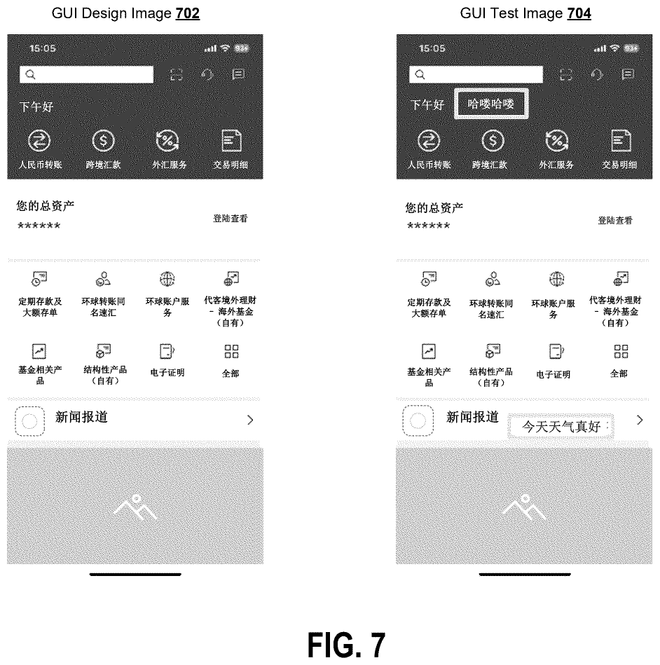

FIG. 7 shows an example GUI test image and an example GUI design image for comparison, according to some embodiments.

In FIG. 7, the GUI design image data object 702 and the GUI test image data object 704 both show the home menu page of an example mobile banking application. The GUI test image 704 only differs from the GUI design image 702 by two regions of Chinese character text. The GUI test image 704 has the Chinese character texts “ [symbol] ” in white against a red background and “ [symbol] ” in red against a white background (highlighted in FIG. 7), which are not present in the corresponding GUI design image 702. This is the type of difference in GUI images that the proposed computational approach is configured to detect and analyze.

Embodiments described herein are configured to handle several types of differences between GUI test images and GUI design images. For example, a GUI test image may differ from a GUI design image due to a lack of precision in certain text or icons, an offset in a feature or text, overlap in features, the images being taken on different devices, dislocation of features, color difference of features or the whole image, or features or the image being stretched.

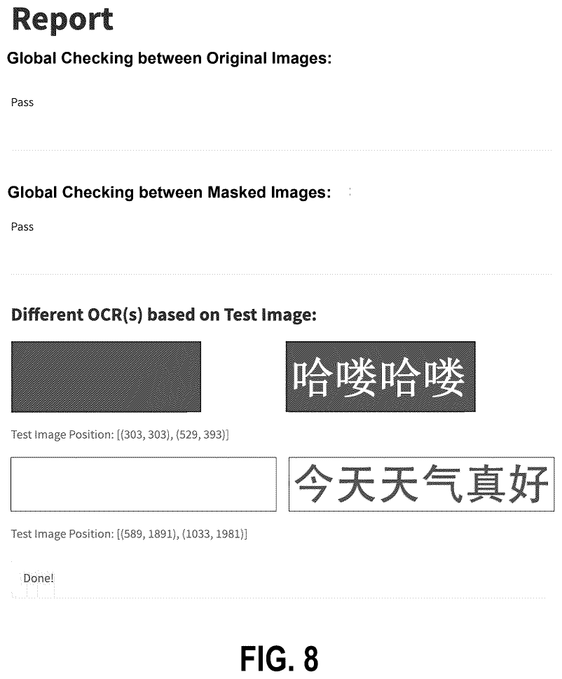

FIG. 8 shows an example GUI test report data object generated by the proposed system for an example GUI test image and an example GUI design image, according to some embodiments. Specifically, FIG. 8 shows an example corresponding GUI test report for the GUI test image and GUI design image shown in FIG. 7.

As FIG. 8 shows, the generated GUI test report includes results for a global check/comparison between the original images and a global check/comparison between the segmented or masked images (i.e., the two types of inputs for the test engine as shown in FIG. 3). The Global Checking between Original Images result indicates whether the scores generated in the test engine for the original GUI test image and GUI design image have passed the thresholds set in the rules engine. Similarly, the Global Checking between Masked Images result indicates whether the scores generated in the test engine for the GUI test image and GUI design image after segmenting out certain OCR text and icons have passed the thresholds set in the rules engine. Depending on the level of similarity testing selected by the user (as shown in FIG. 6), the set thresholds will vary, which alters the difficulty of achieving a “pass” result in the GUI test report.

In FIG. 8, both the Global Checking between Original Images result and the Global Checking between Masked Images result are a “pass”, indicating that the GUI test image and GUI design image from FIG. 7 are similar enough to pass the thresholds set in the rules engine. The GUI test report further indicates a Different OCR(s) based on Test Image score that lists OCR regions that differ in the GUI test image as compared to the GUI design image. The result also indicates the position of each specific OCR region in the GUI design image as compared to the GUI test image. In FIG. 8, the GUI test image differs by two regions of Chinese character text. The GUI test image has the Chinese character texts “ [symbol] ” in white against a red background and “ [symbol] ” in red against a white background, as indicated by the second image in each row of the results under Different OCR(s) based on Test Image. This is compared to the GUI design image which just has a plain OCR regions of a red background and white background, respectively.

In some embodiments, the output GUI test report can be used to generate a set of recommended text instructions for an improved rendering of the reference GUI design image data object by inputting the reference GUI design image data object and the generated output test report into a system for automatic generation of user interface rendering code, where the generated set of recommended text instructions can be transmitted to a development testing environment for compilation and execution as a rendered user interface visual element accessible to the user.

In some embodiments, the test engine can obtain a set of similarity scores for the improved rendering of the reference GUI design image data object; set a first level development threshold for the set of similarity scores; determine the set of similarity scores reaches or exceeds the first level development threshold associated with the set of similarity scores; and in response to reaching or exceeding the value of the first level development threshold, automatically transmit the generated set of recommended text instructions to a development testing environment for compilation and execution as a rendered user interface visual element accessible to the user.

In some embodiments, the test engine can also set a second level production threshold for the set of similarity scores; determine the set of similarity scores reaches or exceeds the second level production threshold; and in response to reaching or exceeding the value of the second level production threshold, automatically deploy the generated set of recommended text instructions to a production server accessible to a plurality of users.

In some embodiments, the generated set of recommended text instructions can be compiled to generate a set of machine language instructions and output the generated set of machine language instructions to the user for re-implementation of a user interface visual element.

In some embodiments, the set of machine language instructions can be further linked into an executable binary file, wherein the executable binary is an aggregation of the set of machine language instructions and can be provided to the user for re-implementation of a user interface visual element.

In some embodiments, the executable binary file can be ran to render a graphical user interface at runtime and output it to the user for re-implementation of a user interface visual element.

In some embodiments, the test engine can set a third level discard threshold for the set of similarity scores; determine the set of similarity scores does not reach the third level discard threshold; and in response to not reaching the value of the third level discard threshold, automatically discard the generated set of recommended text instructions.

A user can use the results in the GUI test report to efficiently pinpoint where potential mistakes or deviations are in the GUI test image compared to the GUI design image and fix the differences if desired to produce a corrected GUI interface.

In some embodiments, the proposed computational approach can be configured to generate a set of recommended text instructions or code for an improved rendering of the GUI design image by inputting the UI design image and the generated GUI test report into a system for automatic generation of user interface rendering code, wherein the generated set of recommended text instructions or code can be reviewed and approved by a human supervisor for transmission to a development testing environment for compilation and execution as output to the user.

As can be understood, the examples described above and illustrated are intended to be exemplary only.

Information and signals may be represented using different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

The functional blocks and modules described herein may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computing system for automated visual testing of graphical user interface designs using image transformations for scoring and evaluation, the system comprising:
a computer processor operating in conjunction with computer memory and a non-transitory computer readable data storage, the computer processor configured to:
receive a candidate data object and a reference data object from a user, each data object representing a graphical user interface design;
transform the candidate and reference data objects into a candidate and reference machine-encoded text objects using optical character recognition for comparison of textual and layout features to generate a first similarity score;
segment the candidate and reference machine-encoded text objects into a candidate and reference sets of pixel clusters using object masks;
generate a candidate and reference image histograms based on the distribution of pixels of the candidate and reference sets of pixel clusters for comparison of color distribution characteristics as between the candidate and reference image histograms to generate a second similarity score;
generate a candidate and reference embedding vectors through image embedding based on the candidate and reference sets of pixel clusters for calculation of a third similarity score, wherein the third similarity score is a cosine similarity score between the candidate and reference embedding vectors;
localize sub-clusters of the candidate and reference sets of pixel clusters to perform template matching between the candidate and reference data objects to generate a fourth similarity score;
compute and extract a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects;
transform the candidate and reference sets of pixel clusters into greyscale format for comparison of luminance and contrast between each pixel of the candidate set of pixel clusters and each pixel of the reference set of pixel clusters to generate a sixth similarity score;
providing the first, second, third, fourth, fifth and sixth similarity scores to a trained machine learning model data architecture for scanning and comparison against a set of passing threshold values; and
generate an output structured data object based on the comparison of the first, second, third, fourth, fifth, and sixth similarity scores against the set of passing threshold values, the output structured data object containing a list of ordered pairs, wherein each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, wherein the output structured data object can be used by the user to correct the difference between the candidate and reference data objects for each ordered pair of the list of ordered pairs.

2. The computing system of claim 1, wherein the computer processor is further configured to generate a set of recommended text instructions for an improved rendering of the reference data object by inputting the reference data object and the generated output structured data object into a system for automatic generation of user interface rendering code, wherein the generated set of recommended text instructions can be transmitted to a development testing environment for compilation and execution as a rendered user interface visual element accessible to the user.

3. The computing system of claim 2, wherein the computer processor is further configured to:
obtain a set of similarity scores for the improved rendering of the reference data object;
set a first level development threshold for the set of similarity scores;
determine reaching or exceeding the first level development threshold associated with the set of similarity scores; and
in response to the reaching or exceeding the value of the first level development threshold, automatically transmit the generated set of recommended text instructions to a development testing environment for compilation and execution as a rendered user interface visual element accessible to the user.

4. The computing system of claim 3, wherein the computer processor is further configured to:
set a second level production threshold for the set of similarity scores;
determine reaching or exceeding the second level production threshold associated with the set of similarity scores; and
in response to the reaching or exceeding the value of the second level production threshold, automatically deploy the generated set of recommended text instructions to a production server accessible to a plurality of users.

5. The computing system of claim 2, wherein the computer processor is further configured to:
compile the generated set of recommended text instructions to generate a set of machine language instructions; and
output the generated set of machine language instructions to the user for re-implementation of a user interface visual element.

6. The computing system of claim 5, wherein the computer processor is further configured to:
link the set of machine language instructions into an executable binary file, wherein the executable binary is an aggregation of the set of machine language instructions; and
output the executable binary file to the user for re-implementation of a user interface visual element.

7. The computing system of claim 6, wherein the computer processor is further configured to:
run the executable binary file to render a graphical user interface at runtime; and
output the rendered graphical user interface to the user for re-implementation of a user interface visual element.

8. The computing system of claim 4, wherein the computer processor is further configured to:
set a third level discard threshold for the set of similarity scores;
determine not reaching the third level discard threshold associated with the set of similarity scores; and
in response to the not reaching the value of the third level discard threshold, automatically discard the generated set of recommended text instructions.

9. The computing system of claim 1, wherein the computer processor is further configured to replace text objects from the candidate and reference data objects with one or more clusters of white pixels by applying the object masks to the candidate and reference machine-encoded text objects before the computer processor segments the candidate and reference machine-encoded text objects.

10. The computing system of claim 9, wherein the computer processor is further configured to replace graphical symbol objects from the candidate and reference data objects with the one or more clusters of white pixels by applying the object masks to candidate and reference machine-encoded text objects before the computer processor segments the candidate and reference machine-encoded text objects.

11. A computing method for automated visual testing of graphical user interface designs using image transformations for scoring and evaluation, the method comprising:
receiving a candidate data object and a reference data object from a user, each data object representing a graphical user interface design;
transforming the candidate and reference data objects into a candidate and reference machine-encoded text objects using optical character recognition for comparison of textual and layout features to generate a first similarity score;
segmenting the candidate and reference machine-encoded text objects into a candidate and reference sets of pixel clusters using object masks;
generating a candidate and reference image histograms based on the distribution of pixels of the candidate and reference sets of pixel clusters for comparison of color distribution characteristics as between the candidate and reference image histograms to generate a second similarity score;
generating a candidate and reference embedding vectors through image embedding based on the candidate and reference sets of pixel clusters for calculation of a third similarity score, wherein the third similarity score is a cosine similarity score between the candidate and reference embedding vectors;
localizing sub-clusters of the candidate and reference sets of pixel clusters to perform template matching between the candidate and reference data objects to generate a fourth similarity score;
computing and extracting a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects;
transforming the candidate and reference sets of pixel clusters into greyscale format for comparison of luminance and contrast between each pixel of the candidate set of pixel clusters and each pixel of the reference set of pixel clusters to generate a sixth similarity score;
providing the first, second, third, fourth, fifth and sixth similarity scores to a trained machine learning model data architecture for scanning and comparison against a set of passing threshold values; and
generating an output structured data object based on the comparison of the first, second, third, fourth, fifth, and sixth similarity scores against the set of passing threshold values, the output structured data object containing a list of ordered pairs, wherein each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, wherein the output structured data object can be used by the user to correct the difference between the candidate and reference data objects for each ordered pair of the list of ordered pairs.

12. The computing method of claim 11, wherein the computing method further comprises:
generating a set of recommended text instructions for an improved rendering of the reference data object by inputting the reference data object and the generated output structured data object into a system for automatic generation of user interface rendering code, wherein the generated set of recommended text instructions can be transmitted to a development testing environment for compilation and execution as a rendered user interface visual element accessible to the user.

13. The computing method of claim 12, wherein the computing method further comprises:
obtaining a set of similarity scores for the improved rendering of the reference data object;
setting a first level development threshold for the set of similarity scores;
determining reaching or exceeding the first level development threshold associated with the set of similarity scores; and
in response to the reaching or exceeding the value of the first level development threshold, automatically transmitting the generated set of recommended text instructions to a development testing environment for compilation and execution as a rendered user interface visual element accessible to the user.

14. The computing method of claim 13, wherein the computing method further comprises:
setting a second level production threshold for the set of similarity scores;
determining reaching or exceeding the second level production threshold associated with the set of similarity scores; and
in response to the reaching or exceeding the value of the second level production threshold, automatically deploying the generated set of recommended text instructions to a production server accessible to a plurality of users.

15. The computing method of claim 12, wherein the computing method further comprises:
compiling the generated set of recommended text instructions to generate a set of machine language instructions; and
outputting the generated set of machine language instructions to the user for re-implementation of a user interface visual element.

16. The computing method of claim 15, wherein the computing method further comprises:
linking the set of machine language instructions into an executable binary file, wherein the executable binary is an aggregation of the set of machine language instructions; and
outputting the executable binary file to the user for re-implementation of a user interface visual element.

17. The computing method of claim 16, wherein the computing method further comprises:
running the executable binary file to render a graphical user interface at runtime; and
outputting the rendered graphical user interface to the user for re-implementation of a user interface visual element.

18. The computing method of claim 14, wherein the computing method further comprises:
setting a third level discard threshold for the set of similarity scores;
determining not reaching the third level discard threshold associated with the set of similarity scores; and
in response to the not reaching the value of the third level discard threshold, automatically discarding the generated set of recommended text instructions.

19. The computing method of claim 11, wherein the computing method further comprises:
replacing text objects from the candidate and reference data objects with one or more clusters of white pixels by applying the object masks to the candidate and reference machine-encoded text objects before the computer processor segments the candidate and reference machine-encoded text objects.

20. A non-transitory computer readable medium storing computer interpretable instructions, which when executed by a computer processor, cause the computer processor to perform a method for automated visual testing of graphical user interface designs using image transformations for scoring and evaluation, the method comprising:
receiving a candidate data object and a reference data object from a user, each data object representing a graphical user interface design;
transforming the candidate and reference data objects into a candidate and reference machine-encoded text objects using optical character recognition for comparison of textual and layout features to generate a first similarity score;
segmenting the candidate and reference machine-encoded text objects into a candidate and reference sets of pixel clusters using object masks;
generating a candidate and reference image histograms based on the distribution of pixels of the candidate and reference sets of pixel clusters for comparison of color distribution characteristics as between the candidate and reference image histograms to generate a second similarity score;
generating a candidate and reference embedding vectors through image embedding based on the candidate and reference sets of pixel clusters for calculation of a third similarity score, wherein the third similarity score is a cosine similarity score between the candidate and reference embedding vectors;
localizing sub-clusters of the candidate and reference sets of pixel clusters to perform template matching between the candidate and reference data objects to generate a fourth similarity score;
computing and extracting a candidate and reference sets of descriptor objects based on local intensity extrema of the candidate and reference sets of pixel clusters for comparison to generate a fifth similarity score, each descriptor object representing a feature point in the data objects, the comparison involving each descriptor object of the candidate set of descriptor objects being compared to each descriptor object of the reference set of descriptor objects;
transforming the candidate and reference sets of pixel clusters into greyscale format for comparison of luminance and contrast between each pixel of the candidate set of pixel clusters and each pixel of the reference set of pixel clusters to generate a sixth similarity score;
providing the first, second, third, fourth, fifth and sixth similarity scores to a trained machine learning model data architecture for scanning and comparison against a set of passing threshold values; and
generating an output structured data object based on the comparison of the first, second, third, fourth, fifth, and sixth similarity scores against the set of passing threshold values, the output structured data object containing a list of ordered pairs, wherein each ordered pair comprises a candidate pixel cluster of the candidate set of pixel clusters and a corresponding reference pixel cluster of the reference set of pixel clusters, wherein the candidate pixel cluster and the corresponding reference pixel cluster are detected by the trained machine learning model data architecture as being a difference between the candidate and reference data objects, wherein the output structured data object can be used by the user to correct the difference between the candidate and reference data objects for each ordered pair of the list of ordered pairs.
